(19) United States
(12) Patent Application Publication
(10) Pub. No.: US 2025/0151179 A1
(43) Pub. Date: May 8, 2025

(54) INDUCTION RAIL HEATER

(71) Applicant: Mark Hornby, Chehalis, WA (US)

(72) Inventor: Mark Hornby, Chehalis, WA (US)

(21) Appl. No.: 18/938,159

(22) Filed: Nov. 5, 2024

Related U.S. Application Data
(60) Provisional application No. 63/547,378, filed on Nov. 5, 2023.

(51) Int. Cl. H05B 6/10; E01B 31/18

(52) U.S. Cl. CPC H05B 6/101; E01B 31/18

(57) ABSTRACT

A system and method for heating and de-stressing Continuously Welded Rail (CWR) during railroad rail installation and maintenance utilizing electromagnetic induction heating coils arranged on a platform capable of traveling on train tracks and over land. The rail heater is equipped with a turntable to reverse work/travel direction as required to facilitate the progress of the work and for setting the the rail heating machine on and off track at grade crossings. The system includes temperature sensors and recording equipment to log the rail heating process and results for record keeping purposes and data collection. The rail heating machine wirelessly monitors the work and performance data to troubleshoot mechanical issues. The induction rail heater is more efficient and safer than conventional open flame systems.

### CROSS-REFERENCE TO RELATED APPLICATIONS

This application claims priority to U.S. provisional application Ser. No. 63/547,378, filed on Nov. 5, 2023, and titled “INDUCTION RAIL HEATER”, which is incorporated herein in its entirety by reference.

### FIELD OF INVENTION

This invention generally relates to installation and maintenance of railroad infrastructure, in particular, applying heat to continuously welded rail for proper installation means and methods.

### BACKGROUND OF THE INVENTION

Various mechanical means have been proposed to apply heat to continuously welded rail (CWR) in order to install or maintain the rail at the desired neutral temperature necessary to comply with rules, regulations and guidelines for CWR installation policy and procedures. Currently CWR rail heating devices heat crucibles with open flames burning diesel, propane and or natural gas to heat and destress CWR running rails. A common problem associated with previous rail heating devices is that they are prone to causing fire hazards and do not transfer heat to the CWR efficiently in windy, wet, or extreme cold work conditions. Accordingly, improvements are sought in the method of delivering and imparting heat to the CWR in a safe and effective manner.

Heating of railroad running rails via induction: Steel expands when it gets hot and shrinks when it gets cold and the surface temperature of the earth fluctuates on a daily basis which creates a problem for the steel running rails used in the construction of railroad infrastructure. If steel gets too hot and expands, the tracks buckle outward to relieve the compressive forces of the expanded metal, a condition called a “Sun Kink,” which creates an unsafe and unstable path for the train that can result in a train derailment.

Another key problem is when steel gets cold and contracts or “shrinks”. In cold weather the rail can be put under such extreme tension that it will break and pull apart, creating a gap in the running rail. This “pull apart” condition create an unstable and unsafe path for the train which can result in train derailment.

The solution to reduce or eliminate “sun kinks” and “pull aparts” is to install the rail at a “neutral temperature” based on the temperature zone for the region where it will be installed. The “neutral temperature” accounts for the seasonal temperature of the region with respect to the high and low temperatures and is selected as a “happy medium” temperature where the expansion and contraction of the steel running rails are minimized. During the construction process, the new rail is laid into the tie plates and spiked down to the wooden cross ties. Once the rail is spiked to the tie, if the rail temperature is below the desired neutral temperature, it is typically heated using open flame, i.e., diesel flames, until it reaches the required temperature and then is mechanically anchored to the wooden cross ties to lock it in place.

Traditional open-flame heating presents a number of problems, including open-flame fire hazard, wildfire hazard, high heat exposure/hot surface burn risk to employees, and difficulty with heating rail in cold/wet/windy conditions. One safety problem with open-flame heaters is that the wooden cross ties and other debris commonly found in the tracks will occasionally catch fire. In some cases, these fires are initially undetectable and smolder for days eventually growing and spreading to other crossties or areas outside of the tracks. Moisture is another problem. If the rail has any moisture on it, or it is raining or windy, the open flame must evaporate the exterior moisture in the rails for the heat to begin to penetrate the steel. Induction heating will heat the steel regardless of outside moisture content or windage.

### SUMMARY OF THE INVENTION

While the way that the present invention addresses the disadvantages of the prior art will be discussed in greater detail below, in general, the present invention provides a method to heat the rail using electromagnetic induction heating technology instead of utilizing any open flame applied to the CWR.

Induction heating eliminates many of the problems associated with current open flame-based rail heaters. For example, by allowing the rail to be heated more efficiently in adverse weather conditions, the work season is effectively extended significantly allowing for more productivity.

One aspect of the invention uses induction heating to heat steel running rails. The induction heating platform can be used with a fifth-wheel transportation platform. A turntable system orients the heater system relative to the longitudinal axis of the rails and rail bed. Integral temperature monitoring helps achieve optimum heating conditions.

Another aspect of the invention features, in some embodiments, an induction coil heating system formatted and designed for de-stressing railroad CWR while in-track.

In some embodiments the induction rail heater is powered by a diesel electric engine that powers the various systems and platforms necessary to propel the rail heating machine up the running rails of the railroad tracks.

In some embodiments the induction rail heater is equipped with an operator's station that records the pre-heat and post heat measurements as well as the footages of CWR and the installation records of the CWR etc. In some embodiments, the induction heating process is monitored and controlled via temperature sensors that interact with a computer system to achieve and record the desired outcome. In some embodiments the computer system uses both wireless and hardwired technology to perform its functions. In some embodiments the rail heater is able to be accessed wirelessly to monitor the work progress as well as to troubleshoot any mechanical or performance issues.

In some embodiments, the induction rail heater is built on a platform that can be transported on a road legal DOT rubber-tired chassis over various roads and highways by a motorized truck. The platform is detached after delivery to a worksite location.

In some embodiments, the induction rail heater is equipped with a turntable that allows the rail heating machine to be easily set onto the railroad tracks at any at-grade railroad crossing.

Another aspect of the invention features, in some embodiments, hyrail gear that raises and lowers onto the railroad running rails and is powered by a drive motor that propels the platform at both working and traveling speeds as necessary.

The present invention contemplates various mechanisms for heating the continuously-welded rail (CWR) using electromagnetic induction coils. The induction rail heater uses induction coil technology to achieve required rail destressing temperatures necessary for CWR installation and maintenance in the most challenging field conditions while greatly improving safety and productivity.

One advantage of the present rail heating device is that fire hazards would be eliminated due to not using open flames. Another advantage of the present invention is that the induction rail heater will impart heat (internally) to the CWR more effectively than open flame heaters during windy, wet, humid, moist or extreme cold conditions. This embodiment affords greater flexibility and better functional integration because jobsite factors such as wind and inclement weather will have less negative impact on rail heating operations in the course of CWR installation and maintenance.

Another advantage of the present invention is the various possibilities for expanded rail laying operations in northern climates where cold weather shortens the allowable work seasons. It is also possible, however, for the induction rail heater to effectively heat CWR in scenarios in which a conventional flame-based heater would be utterly ineffective. For example, if necessary, the induction rail heater can heat CWR rail even if the rail is completely wet from rain or even encased in a thin layer of ice. This results in safer and more efficient CWR destressing operations. The induction rail heater reduces operational risk and downtime while simultaneously increasing safety by eliminating hazards present from open-flame heating methods.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures, and

FIG. 1 illustrates a perspective view of a rail induction heater according to one embodiment;

FIG. 2 illustrates a top view of the rail induction heater of FIG. 1;

FIG. 3 illustrates a side view of the rail induction heater of FIG. 1; and

FIG. 4 illustrates a bottom view of the rail induction heater of FIG. 1.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, drive mechanisms and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

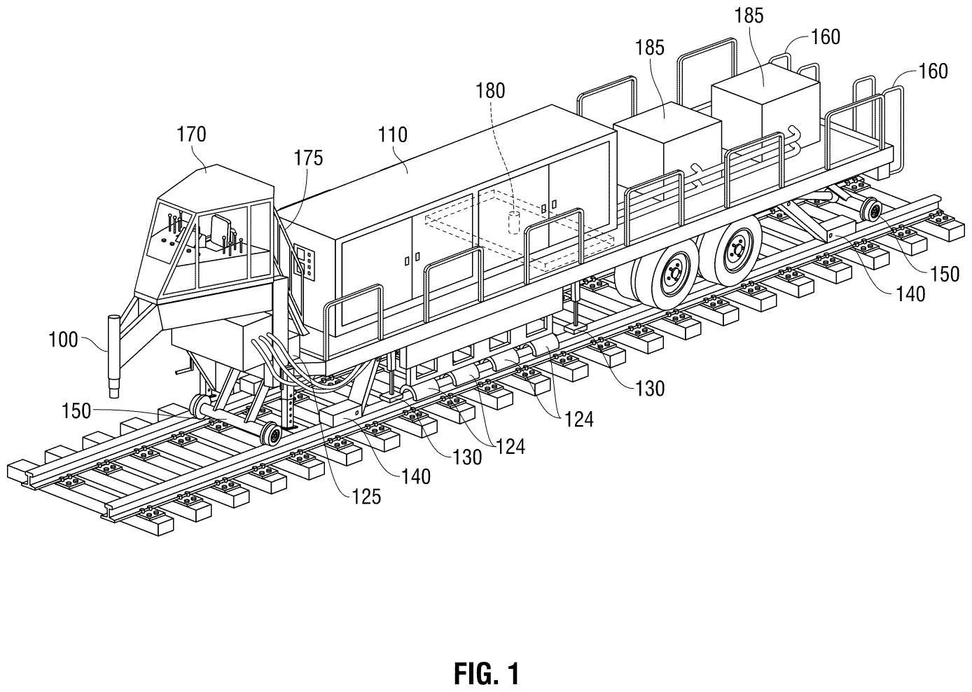

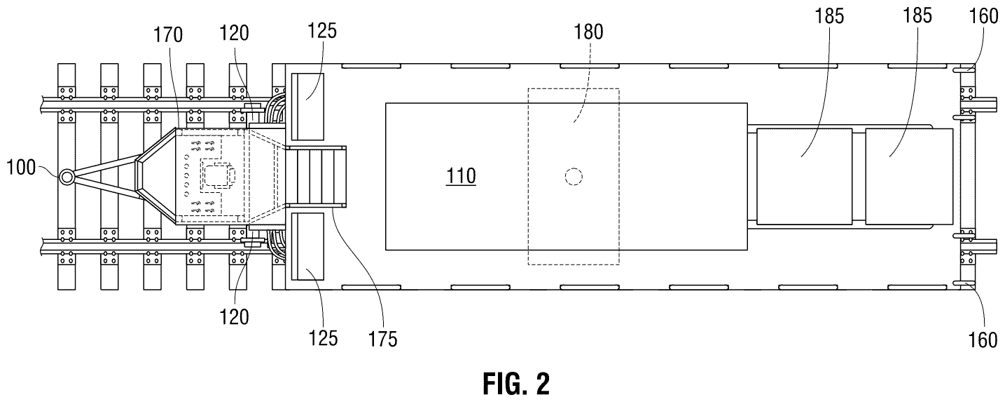

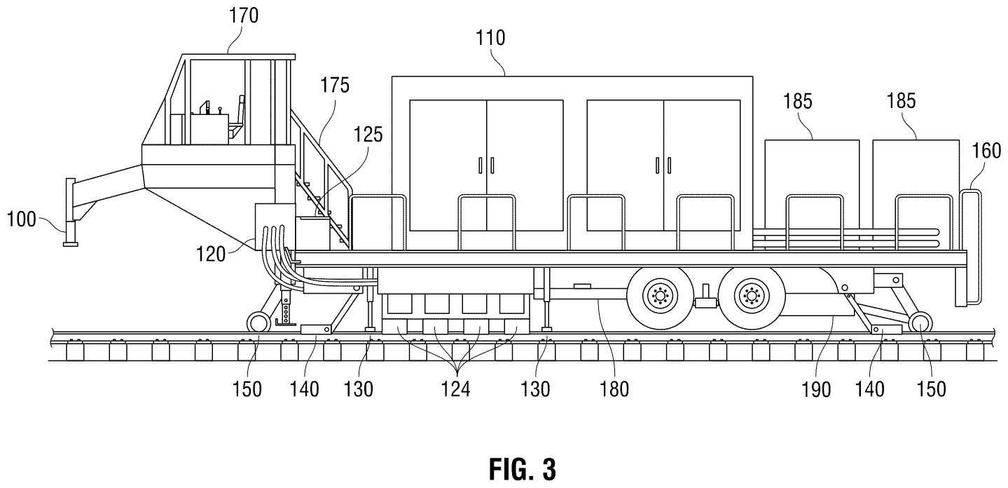

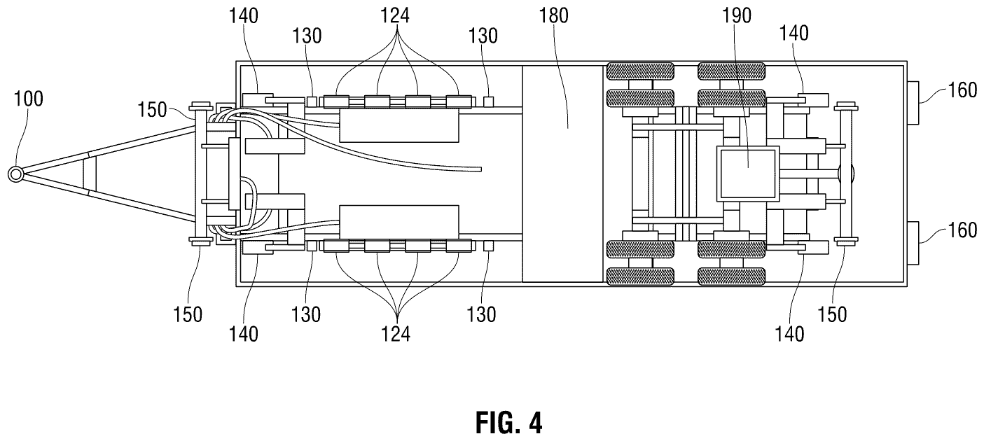

With reference to FIGS. 1-4, an induction rail heater is depicted for railroad construction and maintenance. In the depicted embodiment, the induction rail heater is configured as a trailer-mounted equipment platform 100. Trailer platform 100 is preferably DOT legal and allows for over-the-road transport, e.g., pulled by a one-ton pickup truck.

Equipment platform 100 includes a diesel-electric power supply 110, e.g., a 100-400 KW diesel-fueled generator and a hydraulic wet kit 120 powered by an electric drive motor. The diesel electric power produced by the enclosed genset supplies all systems necessary for work and travel with the energy required to facilitate their respective functions.

Equipment platform 100 includes induction heating coils 124 powered by diesel generator 110 and tailored to the rail profile to be heated and to the work speed necessary. Induction heating coils 124 are designed to optimize heat transfer of the electricity produced by diesel generator 110 based on the physical properties and shape of the CWR. The coils 124 can heat at varying intensities and speeds based on the needs of the velocity required by the CWR de-stressing crew. Cooling units 185 provide for controlled cooling of induction heating coils 124. Cooling units 185 are necessary to prevent induction heating coils 124 from overheating and causing equipment failure. Cooling units 185 work by circulating and cooling liquid which is constantly pumped through induction heating coils 124 via tubing.

A rail temperature sensor 130, e.g., an infrared temperature sensor, monitors pre-existing, working, and final rail temperatures, which are recorded at the operating station for recordkeeping purposes. When the rail heater is in work mode, the initial temperature sensor 130 will register the temperature of the incoming rail and assign that data to a point on the rail based on a devise measuring the lineal footage of rail passing through the heater. The secondary temperature sensor will register the temperature of the rail as it passes out of the heating elements allowing the operator to adjust the controls according to the target rail temperature required. Start and stop stations will be marked on the rail along with other necessary details required by the CWR installation policy of the railroad where the work is being performed. In this way each lineal foot of rail being heated can be tracked and monitored with the corresponding data available after the destressing is complete.

A variable frequency bi-directional rail vibrator 140 is lowered onto the head of the rail when in work mode and vibrates at a suitable frequency to allow the rail to move through the plates freely. Vibrators 140 are necessary to keep the rail from “binding” in the tie plates and skewing the cross ties as the rail “grows” in length or “expands” due to the increase in temperature. Vibrators 140 can work going forward and backwards while in work mode. Vibrators 140 can be raised manually in the event of power failure to allow the the rail heating machine to travel down the rails and clear the track.

A hi-rail travel system 150 allows hi-rail wheels to be lowered once the the rail heating machine is placed on the running rails of the railroad tracks to allow for on-track travel in either direction. Platform 100 and induction rail heater coils 124 may be movable along a pair of rails on on-road using a bi-directional electric motor propulsion drive and braking system 190. The electric drive/braking system 190 may power the rubber-tired axles for both travel and work modes. Speed is controlled via a variable frequency drive (VFD).

Equipment platform 100 preferably includes an ambidextrous control station 170 moveable from left to right sides of the equipment platform to allow for clear line of sight of either rail. Control station 170 includes a central computer system for monitoring and control of the induction rail heater platform travel and work functions. The control station computer also records all pertinent rail heating information for daily destressing rail reports. Control station 70 is accessible via ladder 160 and stairs 175. Optional storage compartments 125 provide for storage of support equipment.

A rail heating machine turntable 180 is engaged via electric/hydraulic actuators, e.g., to provide 180-degree rotation of the the rail heating machine when necessary, from a stationary position. Turntable 180 consists of hydraulic cylinders that lift the the rail heating machine up in the air while balanced and allow the the rail heating machine to spin freely 360 degrees to allow the heater to change work/travel directions as necessary. As best seen in FIG. 1, according to one embodiment, turntable 180 includes a “foot” movable down or up by a hydraulic cylinder, which lifts and lowers the the rail heating machine at the center of gravity allowing the the rail heating machine to pivot freely when pushing perpendicular to the rails from either end until the required rotation is complete, and the the rail heating machine is lowered back down onto the rails.

Accordingly, the present invention provides a mobile rail induction heater platform for heating railroad rails. Various alternative embodiments may include measuring and recording rail temperature and rail footages and calculating and storing necessary records and data.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A moveable railroad rail heating system comprising:
a rollable platform;
one or more induction heating coils positioned on the rollable platform to heat an adjacent railroad rail via induction heating; and
a generator electrically connected to the induction heating coils.

2. The moveable railroad rail heating system of claim 1, further comprising a turntable configured to alternately align the platform with a railroad and with a roadway intersecting the railroad.

3. The moveable railroad rail heating system of claim 1, further comprising hardware and software for wireless monitoring of the heating process as well as accessing all rail heating machine data in real time to allow for mechanical troubleshooting.

4. The moveable railroad rail heating system of claim 1, further comprising a propulsion system for propelling the system down the railroad tracks via a primary electronic drive motor, equipped also with a secondary hydraulic drive motor in the event of failure of the primary drive motor.

5. The moveable railroad rail heating system of claim 1, further comprising a computing station for real-time monitoring with respect to the existing rail temperature as well as required heating data and machine controls necessary to heat the rail steel appropriately according to the necessary CWR heating plan.

6. A method of heating a railroad rail comprising the steps of:
positioning a rollable platform atop railroad rails;
positioning induction rail heaters carried by the rollable platform adjacent a portion of a railroad rail to be heated;
powering the induction rail heaters with a generator to achieve a target temperature;
monitoring a temperature of the portion of the railroad rail; and
ceasing heating of the induction rail heaters upon reaching the target temperature.

7. The method of claim 6, further comprising wirelessly monitoring rail heater machine performance via a control station to monitor work in real time and to diagnose mechanical functions remotely.
